(19) United States
(12) Patent Application Publication
(10) Pub. No.: US 2023/0392083 A1
(43) Pub. Date: Dec. 7, 2023

(54) SYSTEMS AND PROCESSES FOR GENERATING A REDUCED CHLORIDE STRIPPED FLUID FROM A HYDROPROCESSING EFFLUENT

(71) Applicant: SHELL OIL COMPANY, Houston, TX (US)

(72) Inventors: Paolo MUCCIOLI, Amsterdam (NL); Edmundo Steven VAN DOESBURG, Amsterdam (NL)

(21) Appl. No.: 18/246,544

(22) PCT Filed: Oct. 12, 2021
(86) PCT No.: PCT/EP2021/078219

§ 371 Date: Mar. 24, 2023

(30) Foreign Application Priority Data
Oct. 14, 2020 (EP) 20201763.8

(51) Int. Cl. C10G 45/04; C10G 7/00

(52) U.S. Cl. CPC C10G 45/04; C10G 7/00; C10G 2300/202; C10G 2300/4081

(57) ABSTRACT

The present disclosure relates to a process for generating a stripped fluid having reduced chloride content, the process comprising stripping chloride from a hydroprocessing effluent using a hot high pressure stripper to generate the stripped fluid and a vapour, wherein the stripped fluid comprises a lower chloride content than the hydroprocessing effluent, and wherein the vapour comprises chloride.

### FIELD OF THE DISCLOSURE

The present disclosure relates, in some embodiments, to processes and systems that generate stripped fluid (e.g., having at least 10% less chloride) from a hydroprocessing reactor effluent formed by hydroprocessing a feed fluid (e.g., crude feed fluid, bio feed fluid, combinations of crude and bio feed fluids).

### BACKGROUND OF THE DISCLOSURE

Humans derive energy from the combustion of hydrocarbon fuel products developed and refined from both renewable (e.g., bio feedstock) and nonrenewable (e.g., fossil fuels) sources. Hydroprocessing systems are used to refine raw feed fluids (e.g., fossil fuels, bio feed stocks, combinations) into hydrocarbon fuels suitable for combustion. However, some contaminants in the feed treated in the hydroprocessing systems can rapidly degrade system components, thereby reducing the commercial and/or environmental feasibility of using such systems.

Hydroprocessing of a feed fluid chemically transforms hydrocarbons contained therein into more desirable hydrocarbons through hydrogenation, hydrocracking, hydrotreating, hydrodeoxidation, and other reactions. Since the feed fluid contains chloride components (e.g., inorganic chlorides, sodium or calcium chloride, organic chlorides), a hydroprocessing reactor that performs this process also generates and contains concentrated levels of hydrogen chloride originated from a chemical reaction of chlorides with hydrogen. The hydrogen chloride can deposit as an ammonium chloride salt in hydroprocessing system components, leading to pressure drop, fouling, and corrosion, which lead to a need for costly system shut-downs, repairs, and replacements.

Existing methods for dealing with chlorides include pretreating feed fluids with aqueous washes to remove water soluble salts (e.g., NaCl). However, aqueous washes only remove water soluble chlorides (e.g., NaCl, KCl) while leaving behind water insoluble organic chlorides (e.g., benzyl chloride). Within the hydroprocessing reactor, the remaining chlorides are transformed into hydrogen chloride (HCl), which accumulates in the system. Ammonia (NH₃) may also be formed in the hydroprocessing reactor from a chemical reaction of the nitrogen compounds present in the raw feed with hydrogen. As the reactor effluent stream is cooled from the temperature required in the hydroprocessing reactor down to low temperatures that are close to ambient temperatures (e.g., 50° C.), ammonium chloride (NH₄Cl) salt can form and deposit in the reactor effluent circuit causing fouling and plugging. The deposition temperature of NH₄Cl salt increases with the concentration of HCl and NH₃ in the reactor effluent stream. If the concentration is too high, the deposition of ammonium chloride salt occurs before water washing can be applied to remove the salt precursors (NH₃, HCl) from the reactor effluent. If a wash water is mixed with the reactor effluent at too high of a temperature, the wash water fully vaporizes and cannot remove or dilute the chloride salt precursors.

Processes and systems are needed that not only reduce chloride content of feed fluids going into a system, but also treat chloride waste products from the reactor effluent to produce a hydrocarbon liquid effluent with a reduced content of chlorides and achieve a reliable operation of a system so that maintenance based shut downs are prevented.

### SUMMARY

Accordingly, there is a need for improved processes and systems for generating a stripped fluid (e.g., having at least 10% less chloride). In some embodiments, a process may include stripping chloride from a hydroprocessing effluent using a hot high pressure stripper to generate the stripped fluid and a vapour effluent. To generate a hydroprocessing effluent, a method may include combining a feed fluid with a hydrogen rich gas in the presence of a catalyst in a hydroprocessing reactor to produce the hydroprocessing effluent. A stripped fluid generated from a hydroprocessing effluent may be used in a quenching of a hydroprocessing reactor. In some embodiments, a stripped fluid may be used by recycling a portion of the stripped fluid into a hydroprocessing reactor. Besides a hydroprocessing effluent, a hydroprocessing reactor may also generate a hydroprocessing fluid that may be used as a fuel. A disclosed method includes fractionally distilling a hydroprocessed fluid to generate at least a first hydrocarbon fraction and a second hydrocarbon fraction.

A stripped fluid may include a lower chloride content than a hydroprocessing effluent. A vapour may include a chloride. A stripped fluid may include at least 10% less chloride than the hydroprocessing effluent. A stripped fluid may include at least 50% less chloride than the hydroprocessing effluent. A feed fluid may include a hydrocarbon and a chloride content ranging from about 0.1 weight parts per million (wppm) to about 20 wppm. A catalyst may include one or more of a cobalt catalyst, a nickel catalyst, a molybdenum catalyst a palladium catalyst, a platinum catalyst. A hydroprocessing reactor may be maintained at a temperature ranging from about 200° C. to about 450° C. A hot high pressure stripper is maintained at a temperature ranging from about 150° C. to about 300° C. A stripping chloride may include a stripping gas including a hydrogen concentration ranging from about 50% to 99% hydrogen, by volume of the stripping gas.

The present disclosure relates to a hydroprocessing system for generating a stripped fluid having a reduced chloride level. A system may include a hydroprocessing reactor configured to produce a hydroprocessing effluent from a feed fluid; and a hot high pressure stripper configured to strip chloride from the hydroprocessing effluent to generate the stripped fluid and a vapour. In some embodiments, besides a hydroprocessing effluent, a system may be configured to generate a hydroprocessed fluid that may be directly salable, used, or further refined. For example, a hydroprocessing fluid may be further refined by a fractional distillation unit. A fractional distillation unit may include a fractional distillation column and a heating element. A fractional distillation unit may be configured to receive a hydroprocessed fluid from a hydroprocessing reactor. A system may include a first heat exchanger connecting a hydroprocessing reactor to a hot high pressure stripper; and a second heat exchanger connecting the hot high pressure stripper to a feed fluid tank and the first heat exchanger. A system may include a vapour wash unit configured to remove a portion of the chloride from a vapour using a water washing to produce a clean hydrocarbon.

A hydroprocessing system may include a feed recycle reservoir connected to the hot high pressure stripper. A feed recycle reservoir is configured to receive a portion of the stripped fluid from the hot high pressure stripper. A feed recycle reservoir is further configured to combine a portion of the stripped fluid with the feed fluid. A hot high pressure stripper may include a stripping gas transfer line configured to transfer a stripping gas comprising a hydrogen rich gas from a stripping gas tank to the hot high pressure stripper. A stripped fluid collection vessel may be connected to a hot high pressure stripper through a stripped fluid transfer line. A stripped fluid collection vessel may be configured to receive a portion of the stripped fluid from a hot high pressure stripper through a stripped fluid transfer line. A hydroprocessing system may include quench facility connected to the hot high pressure stripper and a hydroprocessing reactor. A quench facility may be configured to receive a portion of a stripped fluid from a hot high pressure stripper. A quench facility may be configured to transfer a portion of a stripped fluid to a hydroprocessing reactor.

### BRIEF DESCRIPTION OF THE DRAWINGS

Some embodiments of the disclosure may be understood by referring, in part, to the present disclosure and the accompanying drawings, wherein:

FIG. 1 is a diagram of a hydroprocessing system configured to generate a stripped fluid, according to specific example embodiments of the disclosure.

### DETAILED DESCRIPTION

The present disclosure relates, in some embodiments, to systems and methods for generating a stripped fluid (e.g., liquid, gas) having reduced chloride levels from a hydroprocessing reactor (e.g., having at least 10% less chloride). A disclosed system can operate on various types of feedstocks, which is an advantage over existing systems that generally only operate on either a crude oil (e.g., a hydrocarbon) or a bio feedstock (e.g., a vegetable oil, an animal fat). For example, a disclosed system may operate with a crude oil, a bio feedstock, or both simultaneously. Additionally, disclosed methods and systems can hydroprocess feed fluids containing chlorides, including relatively high concentrations of chlorides, such as those containing greater than 1 weight parts per million (wppm) of a chloride. In existing systems, chlorides contained within feed fluids accumulate during hydroprocessing operations as either hydrogen chloride (HCl) or ammonium chloride (NH₄Cl), which may contribute to corrosion, fouling, or plugging of system components and increased system down time. Accumulation of chlorides may occur as they sublimate onto various system components. In existing systems, the concentration of chlorides in the feed fluid is preferred to be very low (e.g., <1 wppm) to minimize fouling and plugging of system components.

Disclosed systems and methods operate by removing chlorides from a hydroprocessing reactor effluent so that they do not accumulate and cause system harm. A disclosed system may remove chlorides from a hydroprocessing reactor effluent at temperatures well above the deposition temperature of the chloride salt. Since the deposition temperature of a chloride increases as the concentration of the chloride in the hydroprocessing reactor effluent increases, disclosed systems that remove the chloride from the hydroprocessing reactor effluent prevent salt deposition in the systems where this effluent is used.

### Systems for Generating a Stripped Fluid

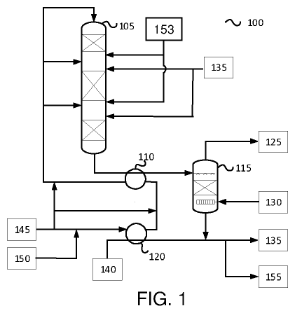

FIG. 1 illustrates one embodiment of a disclosed system 100 that may generate a stripped fluid having reduced chloride levels. A system 100 includes various components used to hydroprocess a feed fluid to produce a hydroprocessing effluent containing a chloride and a hydrocarbon. A system 100 may include a hydroprocessing reactor 105 configured to generate a hydroprocessed effluent that may contain hydrogen chloride (HCl) and ammonia (NH₃). A system may contain a hot high pressure stripper 115 that may strip a chloride (e.g., HCl) and ammonia from a hydroprocessing effluent to generate a chloride containing vapour and a stripped fluid. A stripped fluid may be low in hydrogen chloride and ammonia. A stripped fluid may contain a hydrocarbon (e.g., C1-C25 hydrocarbons). In some embodiments, a hot high pressure stripper 115 may generate a chloride containing vapour from a stripper overhead and a stripped fluid from a stripper bottom. A system may contain a first heat exchanger 110 that connects a hydroprocessing reactor 105 to a hot high pressure stripper 115. A first heat exchanger 110 may cool down and partially condense a hydroprocessing reactor 105 effluent. In some embodiments, a first heat exchanger 110 may use a hydroprocessing reactor effluent to preheat a colder raw feed before it is transferred to a hydroprocessing reactor 105.

A system 100 may be configured to transfer a feed fluid from a feed fluid tank 145 to a hydroprocessing reactor 105 through a feed fluid transfer line. A temperature of a feed fluid may be increased by exchanging heat with a hydroprocessing reactor effluent 105 in a first heat exchanger 110. Additionally, a temperature of a feed fluid may be increased by exchanging heat with a stripped fluid received from the stripper bottom in second heat exchanger 120. In some embodiments, a fired heater may be used to preheat the feed fluid up to the required temperature before it enters a hydroprocessing reactor 105. In some embodiments, a portion of feed fluid may be transferred to a hydroprocessing reactor 105 from another source instead of from a feed fluid tank 145. For example, a portion of a feed fluid may be transferred from a bottom of a hot high pressure stripper 115. A feed fluid may enter a hydroprocessing reactor 105 at various locations including a top of the hydroprocessing reactor 105 and one or more side locations between catalyst beds contained within the hydroprocessing reactor 105. A system 100 may include a hydrogen rich gas tank 150 connected to a hydroprocessing reactor 105 through a hydrogen rich gas connector. A system 100 may be configured to transfer a hydrogen rich gas from a hydrogen rich gas tank 150 to a hydroprocessing reactor 105 through a hydrogen gas transfer line. A hydrogen rich gas may be transferred from a recycle gas stream produced within the system 100 or from a hydrogen source external to system 100 or a combination of both. A hydrogen rich gas 150 may be mixed with the feed fluid before entering the hydroprocessing reactor 105. A hydrogen rich gas may be provided by a quench hydrogen rich gas tank 150 and may be used as quench gas when transferred directly to a hydroprocessing reactor 105. According to some embodiments, a hydroprocessing reactor 105 may be configured to combine a feed fluid with a hydrogen rich gas in the presence of catalyst in a hydroprocessing reactor 105 to produce a hydroprocessing effluent containing hydrocarbons, and other compounds including hydrogen chloride and ammonia.

A feed fluid may contain a chloride content ranging from about 0.1 wppm to about 20 wppm (e.g., wppm by weight). A chloride content may be expressed as chlorine (e.g., Cl⁻). In some embodiments, a feed fluid may contain a chloride content ranging from about 0.1 wppm to about 0.5 wppm, or about 0.25 wppm to about 0.75 wppm, or about 0.5 wppm to about 1.0 wppm, or about 0.75 wppm to about 1.25 wppm, where about includes plus or minus 0.25 wppm. A feed fluid may contain a chloride content ranging from about 1.0 wppm to about 5.0 wppm, or about 2.5 wppm to about 7.5 wppm, or about 5.0 wppm to about 10.0 wppm, or about 7.5 wppm to about 12.5 wppm, or about 10.0 wppm to about 15.0 wppm, or about 12.5 wppm to about 17.5 wppm, or about 15.0 wppm to about 20.0 wppm, where about includes plus or minus 1.25 wppm. A feed fluid may contain a chloride content of about 0.1 wppm, or about 0.5 wppm, or about 1.0 wppm, or about 1.5 wppm, or about 2.0 wppm, or about 2.5 wppm, or about 3.0 wppm, or about 3.5 wppm, or about 4.0 wppm, or about 4.5 wppm, or about 5.0 wppm, where about includes plus or minus 0.25 wppm. A feed fluid may contain a chloride content of about 5 wppm, or about 7.5 wppm, or about 10.0 wppm, or about 12.5 wppm, or about 15.0 wppm, or about 17.5 wppm, or about 20.0 wppm, where about includes plus or minus 2.5 wppm. In some embodiments, a feed fluid may be a high chloride feed having a chloride content that is greater than about 1 wppm.

According to some embodiments, a hydroprocessing effluent may contain a chloride concentration ranging from about 0.1 wppm to about 100 wppm, or greater. A hydroprocessing effluent may contain a chloride concentration from about 0.1 wppm to about 100 wppm. A hydroprocessing effluent may contain a chloride concentration from about 0.1 wppm to about 10 wppm, or about 5 wppm to about 15 wppm, or about 10 wppm to about 20 wppm, or about 15 wppm to about 25 wppm, or about 20 wppm to about 30 wppm, or about wppm to about 35 wppm, or about 30 wppm to about 40 wppm, or about 35 wppm to about 45 wppm, or about 40 wppm to about 50 wppm, or about 45 wppm to about 55 wppm or about 50 wppm to about 60 pm, or about 55 wppm to about 65 wppm, or about 60 wppm to about 70 wppm, or about 65 wppm to about 75 wppm, or about 70 wppm to about 80 wppm, or about 75 wppm to about 85 wppm, or about 80 wppm to about 90 wppm, or about wppm to about 95 wppm, or about 90 wppm to about 100 wppm, where about includes plus or minus 5 wppm. A hydroprocessing effluent may contain a chloride concentration of about 0.1 wppm, or about 2 wppm, or about 3 wppm, or about 4 wppm, or about 5 wppm, or about 6 wppm, or about 7 wppm, or about 8 wppm, or about 9 wppm, or about 10 wppm, where about includes plus or minus 0.5 wppm. A hydroprocessing effluent may contain a chloride concentration of about 10 wppm, or about 20 wppm, or about 30 wppm, or about 40 wppm, or about 50 wppm, or about 60 wppm, or about 70 wppm, or about 80 wppm, or about wppm, or about 100 wppm, where about includes plus or minus 5 wppm.

According to some embodiments, a system 100 may be configured to combine a hydrogen rich gas with a catalyst and a feed fluid in a hydroprocessing reactor 105 to generate a hydroprocessing effluent. In some embodiments, besides a hydroprocessing effluent, a system may be configured to also generate a hydroprocessed fluid that may be directly used as a hydrocarbon product or further refined. A hydroprocessed fluid may be generated in a system 100 by combining a hydrogen rich gas with a catalyst and a feed fluid. A hydrogen rich gas may be supplied to a hydroprocessing reactor 105 from a hydrogen rich gas tank 150 through a hydrogen rich gas transfer line. A hydroprocessing reactor 105 may be charged with a hydrogen rich gas at a hydrogen rich gas pressure ranging from about 150 psi to about 3,000 psi. A hydrogen rich gas pressure may include a range from about 150 psi to about 250 psi, or about 250 psi to about 500 psi, or about 750 psi, or about 750 psi to about 1,000 psi, about 1,050 psi to about 1,250 psi, or about 1,250 psi to about 1,500 psi, or about 1,750 psi, or about 1,750 psi to about 2,000 psi, about 2,050 psi to about 2,250 psi, or about 2,250 psi to about 2,500 psi, or about 2,750 psi, or about 2,750 psi to about 3,000 psi, where about includes plus or minus 125 psi. A hydrogen rich gas includes a hydrogen and a hydrocarbon. A hydrocarbon of a hydrogen rich gas includes C1-C5 alkanes. In some embodiments, a hydrocarbon of a hydrogen rich gas may include mostly C1-C5 alkanes. A hydrogen rich gas includes water, C6 alkanes, CO, and H₂S. A hydrogen rich gas may have a hydrogen content of from about 50% to about 60%, or about 60% to about 70%, or about 70% to about 80%, or about 80% to about 90%, or about 90% to about 99%, by volume of the hydrogen rich gas, where about includes plus or minus 5%. A hydrogen rich gas may have an alkane content of from about 1% to about 10%, or 10% to about 20%, or 20% to about 30%, or 30% to about 40%, or about 50% to about 60%, or about 60% to about 70%, or about 70% to about 80%, or about 80% to about 90%, or about 90% to about 99%, by volume of the hydrogen rich gas, where about includes plus or minus 5%. A hydrogen rich gas may include an alkane including, but not limited to, methane, ethane, propane, butane, pentane, mixtures thereof, and isomers thereof.

In some embodiments, a hydroprocessing reactor 105 may be configured to contain a catalyst including one or more of a palladium catalyst, a platinum catalyst, a nickel catalyst, a cobalt catalyst, a nickel catalyst, and a molybdenum catalyst.

According to some embodiments, a system 100 may include a hydroprocessing reactor 105 containing a reactor vessel having one or more thermocouples. A thermocouple may be configured to maintain a reactor vessel temperature at a range from about 200° C. to about 450° C. A thermocouple may be configured to maintain a reactor temperature at a range from about 200° C. to about 250° C., or about 250° C. to about 300° C., or about 300° C. to about 350° C., or 350° C. to about 400° C., or 400° C. to about 450° C., where about includes plus or minus 25° C.

In some embodiments, a system 100 may be configured to generate a hydroprocessed fluid in a hydroprocessing reactor 105. A hydroprocessed fluid may be a fluid that has been processed through one or more of the following steps: hydrotreatment, hydrogenation, hydroisomerization, and/or hydrocracking. In some embodiments, a hydroprocessed fluid may include any hydrocarbon including alkanes, branched alkanes, linear alkanes, alkenes, alkynes, aryls, aromatics, and combinations thereof.

In some embodiments, a hydroprocessed fluid may have a sulfur concentration of wppm or less. A hydroprocessed fluid may have a sulfur concentration of less than about 5,000 wppm, or less than about 4,500 wppm, or less than about 4,000 wppm, or less than about 3,500 wppm, or less than about 3,000 wppm, or less than about 2,500 wppm, or less than about 2,000 wppm, or less than about 1,500 wppm, or less than about 1,000 wppm, or less than about 500 wppm, or less than about 1 wppm, where about includes plus or minus 250 wppm. A hydroprocessed fluid may have a sulfur concentration of less than about 100 wppm, or less than about 90 wppm, or less than about 80 wppm, or less than about 70 wppm, or less than about 60 wppm, or less than about 50 wppm, or less than about 40 wppm, or less than about 30 wppm, or less than about 20 wppm, or less than about 10 wppm, or less than about 1 wppm, where about includes plus or minus 5 wppm. A disclosed process may produce low sulfur hydroprocessed fluids having reduced sulfur dioxide emissions when combusted (e.g., combustion in automotive vehicles, aircraft, railroad locomotives, ships, gas or oil burning power plants, residential and industrial furnaces, and other forms of fuel combustion) as compared to hydroprocessed fuels having higher sulfur content.

According to some embodiments, as shown in FIG. 1, a system 100 may include a hydroprocessing reactor 105 connected to a hot high pressure stripper 115 through a first heat exchanger 110. A hot high pressure stripper 115 may contain a stripping column and may be configured to strip chloride from a hydroprocessing effluent to generate a stripped fluid containing a hydrocarbon and a vapour containing a chloride. A stripped fluid may have less chloride than the hydroprocessing effluent. A stripped fluid may have from about wt. % to about 99 wt. % less chloride than the hydroprocessing effluent. A stripped fluid may have about 10 wt. %, or about 20 wt. %, or about 30 wt. %, or about 40 wt. %, or about wt. %, or about 60 wt. %, or about 70 wt. %, or about 80 wt. %, or about 90 wt. %, or about 99 wt. % less chloride than a hydroprocessing effluent, where about includes plus or minus 5 wt. %. A stripped fluid may have from about 10 wt. % to about 20 wt. %, or about wt. % to about 30 wt. %, or about 30 wt. % to about 40 wt. %, or about 40 wt. % to about 50 wt. %, or about 50 wt. % to about 60 wt. %, or about 60 wt. % to about 70 wt. %, or about wt. % to about 90 wt. % or about 90 wt. % to about 99 wt. % less chloride than a hydroprocessing effluent, where about includes plus or minus 5 wt. %. A hot high pressure stripper 115 may be configured to remove ammonia and chlorides in forms including hydrogen chloride, ammonium chloride, and combinations thereof. For example, a hot high pressure stripper 115 may be configured to remove hydrogen chloride as a gas from a hydroprocessing effluent to produce a stripped fluid. A stripped fluid may contain a hydrocarbon including alkanes, branched alkanes, linear alkanes, alkenes, alkynes, aryls, aromatics, and combinations thereof

According to some embodiments, a hot high pressure stripper 115 may operate at a pressure ranging from about 150 psi to about 3,000 psi and at a temperature ranging from about 150° C. to about 300° C. A hot high pressure stripper 115 may operate at a pressure ranging from about 150 psi to about 250 psi, or about 250 psi to about 500 psi, or about 750 psi, or about 750 psi to about 1,000 psi, about 1,050 psi to about 1,250 psi, or about 1,250 psi to about 1,500 psi, or about 1,750 psi, or about 1,750 psi to about 2,000 psi, about 2,050 psi to about 2,250 psi, or about 2,250 psi to about 2,500 psi, or about 2,750 psi, or about 2,750 psi to about 3,000 psi, where about includes plus or minus 125 psi. A hot high pressure stripper 115 may operate at a temperature ranging from about 150° C. to about 200° C., or 200° C. to about 250° C., or about 250° C. to about 300° C., where about includes plus or minus 25° C. Pressure within a hot high pressure stripper 115 may result from the hydroprocessing reactor circuit pressure. A hot high pressure stripper 115 may include a thermocouple configured to regulate a temperature of a hydroprocessing reactor effluent transferred to the hot high pressure stripper 115. In some embodiments, a hot high pressure stripper 115 may use a stripping gas provided by a stripping gas tank 130 to strip a chloride from a hydroprocessing effluent. A stripping gas tank 130 may be connected to a hot high pressure stripper 115 through a stripping gas connector. A stripping gas may include a hydrogen rich gas which may be transferred from a recycle gas stream produced within the system 100 or from a hydrogen source external to system 100 or a combination of both.

A hot high pressure stripper 115 may be configured to remove a hydrogen chloride and ammonia from a hydroprocessing effluent. A system 100 may include a vapour wash unit 125 configured to remove a chloride from a vapour using water washing to produce a chloride containing aqueous solution and a clean hydrocarbon.

As shown in FIG. 1, in some embodiments, a disclosed system 100 may include a stripped fluid collection vessel 140 connected to a hot high pressure stripper 115 through a stripped fluid transfer line. A stripped fluid transfer line may connect a stripper bottom of a hot high pressure stripper 115 to a stripped fluid collection vessel 140. A system 100 may be configured to transfer a portion of a stripped fluid from a hot high pressure stripper 115 to a quench facility 135. A quench facility 135 may connected to a hydroprocessing reactor 105 in multiple sections through a series of quench connectors. In some embodiments, a stripped fluid from a quench facility 135 may be cooled before entering a hydroprocessing reactor. A stripped fluid from a quench facility 135 may enter a hydroprocessing reactor in multiple locations between catalyst beds. A portion of a stripped fluid from a hot high pressure stripper 115 may be stored in a feed recycle reservoir 155 so that it may be mixed with a feed and added to a hydroprocessing reactor 105. The mixing may be done at various locations in the feed line leading to a hydroprocessing reactor 105 (e.g. upstream the heat exchangers or between multiple heat exchangers). A portion of a stripped fluid from a hot high pressure stripper 115 may serve as liquid quench for a hydroprocessing reactor 105 when it is mixed with the feed just before entering a hydroprocessing reactor 105. A portion of a stripped fluid from a hot high pressure stripper 115 (e.g., bottom of hot high pressure stripper 115) may supply heat to a feed for a hydroprocessing reactor 105 by means of second heat exchanger 120 to increase an energy efficiency of the hydroprocessing reactor 105. In some embodiments, second heat exchanger 120 may transfer heat to first heat exchanger 110. Since the heat around second heat exchanger 120 is sufficiently high, it ensures that the metal tube of first heat exchanger 110 maintains a high enough temperature to prevent salt deposition where the first heat exchanger 110 connects to the hydroprocessing reactor 105. Maintaining a high enough temperature to prevent salt deposition where the first heat exchanger 110 connects to the hydroprocessing reactor 105 prevents fouling and plugging on the hydroprocessing reactor effluent side of the first heat exchanger 110. In some embodiments, a second heat exchanger 120 connects a hot high pressure stripper 115 with quench facility 135, a hydroprocessed fluid reservoir 155, a feed fluid tank 145, and first heat exchanger 110.

A disclosed system 100 may include more than one hydroprocessing stages. Each hydroprocessing stage may include one or more hydroprocessing reactors. Each hydroprocessing reactor may include one or more catalyst beds. A system 100 may have one hydroprocessing stage, two hydroprocessing stages, three hydroprocessing stages, four hydroprocessing stages, or more. If a hydroprocessing reactor 105 has two hydroprocessing stages, a stripped fluid may be sent to a second hydroprocessing stage of a system 100 through a stage connector. For example, a stripped fluid from a stripped fluid tank 140 may be sent to a second stage of the hydroprocessing reactor 105 through a second stage connector. In some embodiments, a stripped fluid from a hot high pressure stripper 115 may be sent to a second stage of a system 100 through a second stage connector.

In some embodiments, a hydroprocessed fluid generated by a hydroprocessing reactor 105 may be directly used or processed further (e.g., distilled). A system 100 may include a fractionation section configured to distill a hydroprocessed fluid into one or more hydrocarbon fractions. A fractionation section may connect to a hydroprocessing reactor 105 through a fractionation connector. A fractionation section may be configured to receive a hydroprocessed fluid from a hydroprocessing reactor 105 through a fractionation connector.

### Processes for Generating a Stripped Fluid

The present disclosure, according to some embodiments, relates to a process for generating a stripped fluid from a hydroprocessing effluent generated by a hydroprocessing reactor 105. A stripped fluid may have a lower chloride content than a hydroprocessing effluent (e.g., at least 10% less chloride content).

According to some embodiments, a process may include combining a feed fluid with a hydrogen rich gas in a hydroprocessing reactor 105 in presence of a catalyst to produce a hydroprocessing effluent. A feed fluid may be transferred to a hydroprocessing reactor 105 from a feed fluid tank 145 through a feed fluid transfer line. A hydrogen rich gas may be transferred to a hydroprocessing reactor 105 from a hydrogen gas tank 150 through a hydrogen gas transfer line. In some embodiments, a feed fluid may include a crude oil (e.g., a hydrocarbon), a bio feedstock (e.g., a vegetable oil), or a combination thereof. A feed fluid may include a hydrocarbon and a chloride content (e.g., ranging from about 0.1 wppm to about 100 wppm, expressed as chlorine and on a weight basis). A feed fluid may contain a chloride content of about 0.1 wppm, or about 5 wppm, or about 10 wppm, or about 15 wppm, or about 20 wppm, or about 25 wppm, or about 30 wppm, or about 35 wppm, or about 40 wppm, or about 45 wppm, or about 50 wppm, or about 55 wppm, or about 60 wppm, or about wppm or about 70 wppm, or about 75 wppm or about 80 wppm, or about 85 wppm or about 90 wppm, or about 95 wppm, or about 100 wppm, where about includes plus or minus 5 wppm. In some embodiments, a process may include washing a feed fluid (e.g., with a water solution) to remove a portion of a chloride from a feed fluid before transferring it to a hydroprocessing reactor 105. For example, a process may include washing a feed fluid (e.g., with a water or a brine) to remove a chloride from a feed fluid.

According to some embodiments, a process may include combining a feed fluid with a hydrogen rich gas in a hydroprocessing reactor 105 and in presence of catalyst to produce a hydroprocessing effluent. A process may combine a feed fluid and a hydrogen rich gas with a catalyst including one or more of a palladium catalyst, a platinum catalyst, a nickel catalyst, a cobalt catalyst, a molybdenum catalyst.

According to some embodiments, a disclosed process produces a hydroprocessing effluent from a hydroprocessing reactor 105. A process may produce a hydroprocessing effluent having a chloride concentration ranging from about 0.1 wppm to about 100 wppm, or greater. A process may generate a hydroprocessing effluent having a chloride concentration of about 0.1 wppm, or about 5 wppm, or about 10 wppm, or about 15 wppm, or about 20 wppm, or about 25 wppm, or about 30 wppm, or about 35 wppm, or about 40 wppm, or about wppm, or about 50 wppm, or about 55 wppm, or about 60 wppm, or about 65 wppm, or about 70 wppm, or about 75 wppm, or about 80 wppm, or about 85 wppm, or about 90 wppm, or about 95 wppm, or about 100 wppm, where about includes plus or minus 5 wppm. In some embodiments, a process includes a step of transferring a hydroprocessing effluent from a hydroprocessing reactor 105 to a hot high pressure stripper 115 through a first heat exchanger 110.

A process may include stripping a chloride from a hydroprocessing reactor 105 effluent to generate a chloride containing vapour and a stripped fluid using a hot high pressure stripper 115. A hot high pressure stripper may be maintained at a temperature ranging from about 150° C. to about 300° C. A stripped fluid may have less chloride than a hydroprocessing effluent. A stripped fluid may have from about 10 wt. % to about 99 wt. % less chloride than the hydroprocessing effluent. A stripped fluid may have about 10 wt. %, or about 20 wt. %, or about 30 wt. %, or about 40 wt. %, or about 50 wt. %, or about 60 wt. %, or about 70 wt. %, or about 80 wt. %, or about 90 wt. %, or about 99 wt. % less chloride than a hydroprocessing effluent, where about includes plus or minus 5 wt. %. A hot high pressure stripper 115 may be configured to remove chlorides from a hydroprocessing effluent in a form including hydrogen chloride, ammonium chloride, sodium chloride, potassium chloride, and combinations thereof.

In some embodiments, a process may including using a stripped fluid to preheat a feed fluid before it is introduced to a hydroprocessing reactor 105 by means of second heat exchanger 120. A stripped fluid may be used to preheat a feed fluid to a temperature ranging from about 50° C. to about 350° C. A stripped fluid may preheat a feed fluid to a temperature of about 50° C., or about 75° C., or about 100° C., or about 125° C., or about 150° C., or about 175° C., or about 200° C., or about 225° C., or about 250° C., or about 275° C., or about 300° C., or about 325° C., or about 350° C., where about includes plus or minus 12.5° C. A method may include using a heat exchanger to prevent deposition of chloride salts on a hydroprocessing reactor 105 effluent side. A transfer of heat from a second heat exchanger 120 to heat exchanger 110 may be sufficiently high to ensure that a tube of metal of heat exchanger 110 on a reactor effluent side (e.g., of a hydroprocessing reactor 105) is higher than the deposition temperature of chlorides, which may prevent salt deposition that may lead to fouling and plugging on the reactor effluent side of the heat exchanger 110. Preheating a feed fluid before it is introduced to a hydroprocessing reactor 105 may lower overall system 100 energy costs as less energy will be needed to maintain reaction temperatures from within the hydroprocessing reactor 105.

According to some embodiments, a method includes generating a hydroprocessed fluid from a hydroprocessing reactor. A hydroprocessed fluid generated by a hydroprocessing reactor 105 may be directly used or processed further (e.g., distilled). In some embodiments, a hydroprocessed fluid may be transferred to a fractionation section through a fractionation section transfer line. A process may include distilling a hydroprocessed fluid in a fractionation section to produce one or more hydrocarbon fractions. A hydrocarbon fraction may include multiple fractions at a range of boiling points. In some embodiments, one or more hydrocarbon fractions may be transferred from a fractional distillation unit to a hydroprocessed fluid reservoir 155 through a distilled fluid transfer line. In some embodiments, one or more hydrocarbon fractions may be transferred from a fractional distillation unit to any collection container.

Persons skilled in the art may make various changes in the shape, size, number, separation characteristic, and/or arrangement of parts without departing from the scope of the instant disclosure. Each disclosed component, system, and process step may be performed in association with any other disclosed component, system, or process step and in any order according to some embodiments. Where the verb “may” appears, it is intended to convey an optional and/or permissive condition, but its use is not intended to suggest any lack of operability unless otherwise indicated. Persons skilled in the art may make various changes in processes of preparing and using a composition, device, and/or system of the disclosure. Where desired, some embodiments of the disclosure may be practiced to the exclusion of other embodiments.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100.

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

What is claimed is:

1. A process for generating a stripped fluid having reduced chloride content, the process comprising:
stripping chloride from a hydroprocessing effluent using a hot high pressure stripper to generate the stripped fluid and a vapour effluent,
wherein the stripped fluid comprises a lower chloride content than the hydroprocessing effluent, and
wherein the vapour comprises a chloride.

2. The process according to claim 1, wherein one of the stripped fluid comprises at least 10% less chloride than the hydroprocessing effluent,
the stripped fluid has at least 50% less chloride than the hydroprocessing effluent, and
the stripping chloride further comprises exposing the hydroprocessing effluent to a stripping gas comprising a hydrogen concentration ranging from about 50% to 99% hydrogen, by volume of the stripping gas.

3. The process according to claim 1, further comprising maintaining the hot high pressure stripper at a temperature ranging from about 200° C. to about 350° C.

4. The process according to claim 1, further comprising:
combining a feed fluid comprising a hydrocarbon and a chloride content of greater than about 1 wppm with a hydrogen rich gas in a hydroprocessing reactor to produce a hydroprocessed effluent and a hydroprocessed fluid.

5. The process according to claim 4, further comprising one or more of:
quenching the hydroprocessing reactor with the stripped fluid;
recycling a portion of stripped fluid into the hydroprocessing reactor; and
fractionally distilling the hydroprocessed fluid to generate at least a first hydrocarbon fraction and a second hydrocarbon fraction.

6. The process according to claim 4, further comprising one or more of:
exposing the feed fluid and the hydrogen rich gas to a catalyst comprising one or more of a cobalt catalyst, a nickel catalyst, a molybdenum catalyst a palladium catalyst, a platinum catalyst,
using at least a portion of the stripped fluid to preheat the feed fluid to a temperature ranging from about 25° C. to about 350° C. before it enters the hydroprocessing reactor, and maintaining the hydroprocessing reactor at a temperature ranging from about 200° C. to about 450° C.

7. A hydroprocessing system that generates a stripped fluid having reduced chloride levels, the system comprising:
(a) a hydroprocessing reactor configured to produce a hydroprocessing effluent from a feed fluid; and
(b) a hot high pressure stripper configured to strip chloride from the hydroprocessing effluent to generate the stripped fluid and a vapour,
wherein the stripped fluid comprises a lower chloride content than the hydroprocessing reactor effluent, and
wherein the vapour comprises chloride.

8. The hydroprocessing system of claim 7, further comprising a fractional distillation unit comprising a fractional distillation column, the fractional distillation unit configured to receive a hydroprocessed fluid from the hydroprocessing reactor.

9. The hydroprocessing system of claim 7, further comprising one or more of:
a KO drum connected to the hot high pressure stripper through a stripping gas transfer line, wherein the KO drum is configured to contain a hydrogen rich gas, and wherein the stripping gas transfer line is configured to transfer the hydrogen rich gas from the KO drum to the hot high pressure stripper;
a vapour wash unit configured to remove a portion of the chloride from the vapour using a water washing to produce a clean hydrocarbon;
a first heat exchanger connecting the hydroprocessing reactor to the hot high pressure stripper; and
a second heat exchanger connecting a stripped fluid collection vessel to a feed fluid tank and the first heat exchanger.

10. The hydroprocessing system of claim 8, further comprising one or more of:
a stripped fluid collection vessel connected to the hot high pressure stripper through a stripped fluid transfer line, wherein the stripped fluid collection vessel is configured to receive a portion of the stripped fluid from the hot high pressure stripper through the stripped fluid transfer line;
a quench facility connected to the hot high pressure stripper and the hydroprocessing reactor, wherein the quench facility is configured to receive a portion of the stripped fluid from the hot high pressure stripper, and wherein the quench facility is further configured to transfer a portion of the stripped fluid to the hydroprocessing reactor; and
a second hydroprocessing stage connected to one or more of the hot high pressure stripper and the stripped fluid collection vessel through a second stage connector, wherein the second hydroprocessing stage is configured to receive a portion of the stripped fluid from one or more of the hot high pressure stripper and the stripped fluid collection vessel through the second stage connector.
